(19) United States
(12) Patent Application Publication
(10) Pub. No.: US 2010/0110847 A1
(43) Pub. Date: May 6, 2010

(54) METHOD OF RECORDING ON A DUAL LAYER RECORD CARRIER, AND DEVICE FOR RECORDING ON A DUAL LAYER RECORD CARRIER

(75) Inventor: Robert Albertus Brondijk, Middelbeers (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/613,576

(22) Filed: Nov. 6, 2009

Related U.S. Application Data
(62) Division of application No. 10/568,204, filed on Feb. 13, 2006.

(30) Foreign Application Priority Data
Aug. 19, 2003 (EP) 03102597.6

(51) Int. Cl. G11B 20/00

(52) U.S. Cl. 369/47.15; G9B/20

(57) ABSTRACT

The invention relates to a method and a device for recording information on a recordable multi-layer DVD disc wherein information is incrementally recorded on the disc such that the area regarded as containing written information on the first information layer is substantially equal to the area regarded as containing written information on the second information layer. However, an area regarded as containing written information may comprise an area where no information is recorded. In this way a recordable disc is produced from which DVD-ROM players can retrieve the recorded information.

The invention relates to a method of recording information on a recordable multi-layer record carrier, such as a dual layer DVD disc. The invention further relates to a recording device in which the above method is implemented.

DVD-ROM discs are well known. This read-only type of record carriers is used for storing large amounts of information, such as for example digitally encoded movies. To be able to store even larger amounts of information, a record carrier may comprise multiple information layers, that is, layers in which the information is stored in the form of optically detectible areas. Dual layer DVD-ROM discs, comprising two such information layers, are currently well known.

Recordable DVD discs, both the write-once type (such as DVD+R) and the rewritable type (such as DVD+R/W), are used for recording large amounts of information. Recently, dual layer versions of these recordable DVD discs have been introduced. Such a dual layer disc comprises two information layers, generally referred to as the L0 and L1 layers. The L0 layer is the information layer located closest to the side of a disc where a radiation beam, such as a laser beam, used for reading and/or recording the information enters the disc.

The information is stored on these record carriers according to specific rules and layouts, generally referred to as Formats, which are described in documents referred to as a Standards.

It is a problem that the information recorded on a dual layer recordable DVD disc cannot always be reproduced on a DVD-ROM player without errors. This, so-called compatibility issue, is especially a problem since a large installed base of DVD-ROM players is already available all around the world.

It is an object of the present invention to provide a method of recording a dual layer recordable DVD disc in such a way that it can be reproduced in DVD-ROM players without errors. The DVD-ROM player may be a player installed, for example in a Personal Computer (PC), or may be a stand-alone DVD-ROM player.

This object is achieved by the method according to the present invention wherein information is incrementally recorded on the disc such that the amount of information written on layer L0 is substantially equal to that written on layer L1.

It was observed that the compatibility problem arises in two cases: 1) when the data is placed entirely on only one information layer, or 2) when the data is placed on both layers, with layer L0 totally filled and layer L1 only partially filled. It appeared that these two cases are non-compliant with the present DVD-ROM Standard because: 1) The DVD-ROM standard states that the information area on the information layer L0 must be about the same size as the information area on the information layer L1, and/or 2) when a drive accesses the beginning of information layer L1 (located at the outside of the disc) it will first jump from layer L0 to layer L1 and then move its tray. However, if the area on layer L1 to which it jumps is unwritten, a drive will most likely crash.

According to an aspect of the present invention this compatibility problem is solved by modifying the Format of the recordable DVD discs in such a way that a method of recording information has the possibility to incrementally fill the disc with information such that the amount of information written on layer L0 is substantially equal to that written on layer L1.

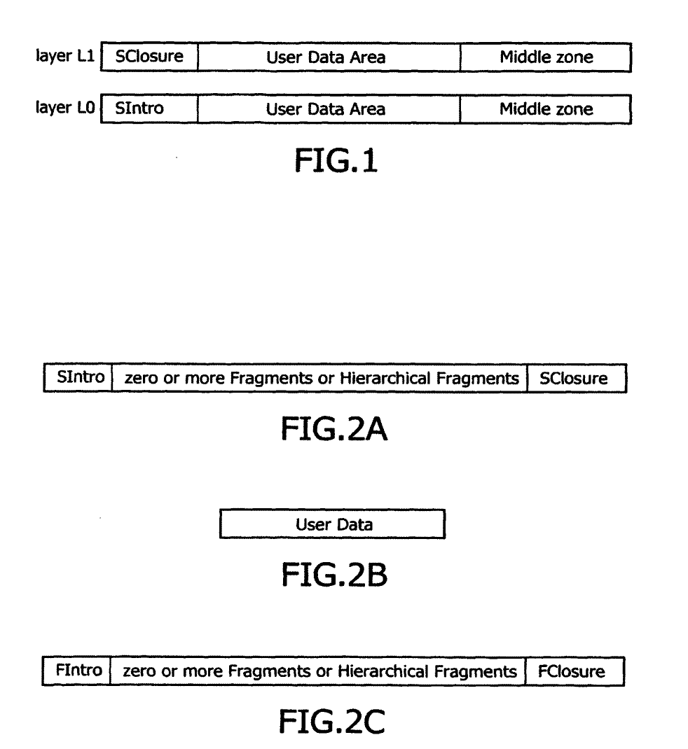

The current Format does not support such an incremental filling process because once information is written to layer L1 and the written area on layer L1 become just as large as the written area on layer L0, then the disc is considered full and no information can be added anymore. This is because the Logical Address is zero at the beginning of the User Data Area on layer L0 (see FIG. 1) and increase linearly to the end of layer L0 up to the Middle zone. Then, after a layer jump, it increases linearly on layer L1 starting at the Middle zone towards the lead-out zone (indicated as SClosure in FIG. 1 in which the two information layers L0 and L1 are schematically shown). Hence, all of the blocks in the Middle zone, both on layer L0 and on layer L1, are lost (that is, are unavailable for recording information). Preferably, these blocks should be available for recording information.

The basic obstruction in the Format is that it is only allowed to record information sequentially in Fragments and in Sessions (a Sessions consisting of one or more Fragments). This implies that one could temporarily skip over a large area on layer L0 by declaring it a Fragment. However, such a skipped Fragment must be written in its entirety before the disc is closed. This is because all Fragments in a Session must be closed before closing a Session, and because only recordable discs with all closed Sessions (that is, a closed disc) are DVD-ROM compliant.

According to an aspect of the present invention a Fragment is allowed to remain open after closing a Session. By allowing the Fragment to remain open after closing the Session, it is made a special type of Fragment. Therefore it is referred to as a Hierarchical Fragment. It is called hierarchical because it may be contained within a Fragment and it may contain itself other Fragments. Preferably, it is a Fragment which itself contains all of the information required to register (that is, create) all Fragments and hierarchical Fragments it may contain.

The present invention will now be described on the basis of a preferred embodiment with reference to the accompanying drawings, in which:

FIG. 1 shows a schematic diagram of a User Data Area on Layer L0 and Layer L1;

FIG. 2a shows a layout of a Session;

FIG. 2b shows a layout of a Fragment;

FIG. 2c shows the layout of an Hierarchical Fragment;

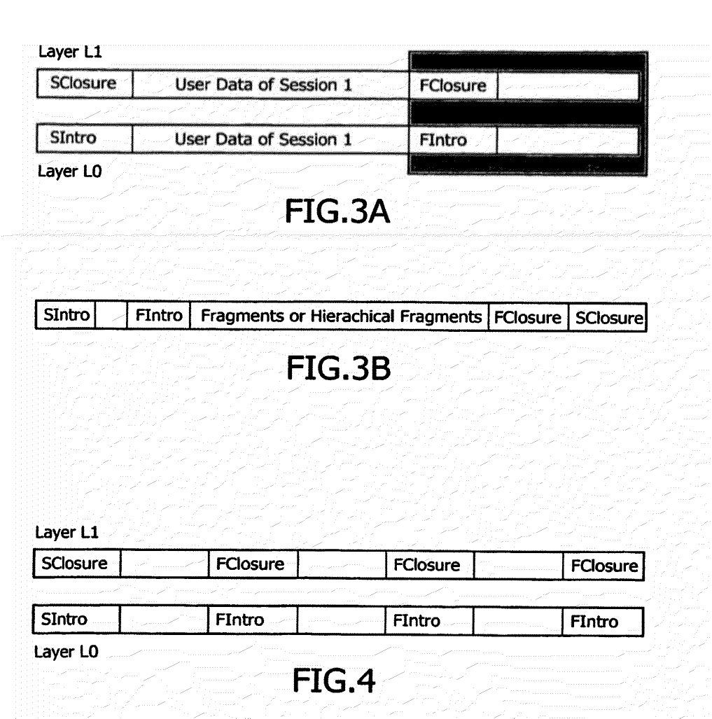

FIG. 3a shows Hierarchical Fragments physically distributed over two layers;

FIG. 3b shows the Hierarchical Fragments of FIG. 3a represented as a single linear address range;

According to an embodiment of the invention, a Session has a layout as shown in FIG. 2A and a Fragment has a layout as shown in FIG. 2B. Each session starts with a session lead-in area (SIntro) and end with a session lead-out area (SClosure).

Now, a Hierarchical Fragment has the layout as shown in FIG. 2C. It starts with a lead-in area (FIntro) and end with a lead-out area (FClosure). A Hierarchical Fragment may contain further Hierarchical Fragments. This may be physically distributed over the two layers of a dual layer disc as is shown in FIG. 3A. When such a dual layer disc is viewed upon as a single linear address range, this would look schematically like shown in FIG. 3B.

Hence, a Hierarchical Fragment is embedded within a Session. This enables a user to leave a track within a Session open. This is possible due to the fact that a track contains its own administration area. Now, it is possible for a disc drive to read what has been written and what has not been written. Preferably, a DVD-ROM drive performs a Hierarchical Fragment search when a disc is inserted to find the number of such Fragments and to determine whether or not they are completely written.

FIG. 4 shows an example an embodiment comprising a hierarchy of three Hierarchical Fragments. Because a disc is filled linearly from the inner radius (on the left) to the outer radius (on the right), it remains DVD-ROM compliant. The logical addresses run linearly over the entire disc. Hence, within a closed Session or a closed Hierarchical Fragment there may be address zones that have not been written yet. However, a DVD-ROM drive will not have any problems with these unwritten addresses because a drive will jump between the layers immediately and not go to the end of one layer before jumping to the next layer.

A device according to the present invention is capable of executing the above-described methods according to the invention. Preferably, next to the supported commands for reserving tracks, inquiring about their sizes, and closing sessions, support for commands like 1) Reserve Hierarchical Track, 2) Get Hierarchical Track Information, and 3) Close Hierarchical Track are implemented.

It is noted that although the invention is explained with reference to a dual layer record carrier, the invention can also be used for record carriers comprising more than two information layers without deviating from the concept of the invention.

1. Method of recording information on a recordable multi-layer record carrier, said record carrier comprising a first information layer and a second information layer for storing the information, wherein information is incrementally recorded in multiple sessions at different times on the disc such that after each different session, the one or more areas that have been formatted on the first information layer are substantially coincident and coextensive to the areas that have been formatted on the second information layer, and one or more areas that remain unformatted on the first information layer are substantially coincident and coextensive to respective areas that remain unformatted on the second information layer, whereby when jumping from a formatted area on one layer to another layer, the jump will not be into one of the unformatted areas.

2. Method according to claim 1, wherein the formatted area on the first information layer and/or the formatted area on the second information layer comprise an area where no information is recorded.

3. Recording device for recording information on a recordable multi-layer record carrier operative for executing a method as claimed in claim 1.

4. A DVD player comprising:
means for inserting a DVD into the player;
a processor;
reading means for controlling the processor for reading information at provided addresses from the inserted DVD;
searching means for controlling the processor for searching for the presence of hierarchical fragments within sessions on the DVD, the searching including providing addresses to the reading means and receiving data from the reading means,
a session being a continuous portion of the DVD address space between a session lead-in area and a session lead-out area, a fragment being a continuous portion of a session between a fragment lead-in area and a fragment lead-out area, each session containing one or more fragments, and an hierarchical fragment being a fragment that contains an entire sub fragment including the fragment lead-in area and fragment lead-out area of the sub fragment, each hierarchical fragment containing one or more sub fragments.

5. The DVD player of claim 4 wherein the searching means searches for and determines if there are any hierarchical fragments when a DVD disc during initialization for a DVD disc, the player initializing for a DVD disc when a disk is inserted into the DVD player when the player is operating.

6. The DVD player of claim 4 wherein one or more hierarchical fragments contain both sub fragments and unrecorded portions.

7. A DVD recorder comprising:
means for inserting a DVD into the recorder;
a processor;
writing means for controlling the processor for writing information at provided addresses to the inserted DVD;
hierarchical writing means for controlling the processor for writing hierarchical fragments within sessions on the DVD and including providing addresses to the writing means,
a session being a continuous portion of the DVD address space between a session lead-in area and a session lead-out area, a fragment being a continuous portion of a session between a fragment lead-in area and a fragment lead-out area, each session containing one or more fragments, and an hierarchical fragment being a fragment that contains an entire sub fragment including the fragment lead-in area and fragment lead-out area of the sub fragment, each hierarchical fragment containing one or more sub fragments.

8. The DVD recorder of claim 4 wherein the hierarchical writing means is for:
writing lead-out areas for hierarchical fragments that contain unrecorded portions, and
writing sub fragments in the unrecorded portions of the hierarchical fragments that already have lead-out areas.

9. A DVD comprising:
a session;
a hierarchical fragment within the session;
a sub fragment within the hierarchical fragment;
wherein a session is a continuous portion of the DVD address space between a session lead-in area and a session lead-out area, a fragment is a continuous portion of a session between a fragment lead-in area and a fragment lead-out area, each session containing one or more fragments, and an hierarchical fragment is a fragment that contains an entire sub fragment including the lead-in area and fragment lead-out area of the sub fragment, each hierarchical fragment containing one or more sub fragments.

10. The DVD of claim 9 comprising:
an unwritten portion following a sub fragment, and both the unwritten portion and the sub fragment are contained within the same hierarchical fragment.

11. The DVD of claim 9 wherein the DVD is multilayer and contains one or more unwritten areas in each layer, each unwritten portion being contained in a fragment, and each unwritten portion being coincident with respective unwritten portions in each of the other layers.

12. A method of recording data on a multi-layer record carrier, comprising:
first writing data to each layer of the record carrier so that the data is written coincident and coextensive in each respective layer; and
at a substantially subsequent time after the first writing, second writing data to each layer of the record carrier so that the data is written coincident and coextensive in each respective layer;
whereby when jumping from a written area on one layer to another layer, the jump will not be into one of the unwritten areas.

13. A method of formatting a multi-layer record carrier, comprising:
first formatting portions of each layer of the record carrier so that the formatted portions are all written coincident and coextensive to each other in each respective layer; and
at a substantially subsequent time after the first formatting, second formatting portions of each layer of the record carrier so that the formatted portions are all written coincident and coextensive to each other in each respective layer;
whereby when jumping from a formatted area on one layer to another layer, the jump will not be into one of the unformatted areas.
